(19) United States
(12) Patent Application Publication
(10) Pub. No.: US 2019/0291256 A1
(43) Pub. Date: Sep. 26, 2019

(54) Multi-Tool

(71) Applicant: Klein Tools, Inc., Lincolnshire, IL (US)

(72) Inventors: William Baronti, Arlington Heights, IL (US); Thomas R. Klein, JR., Lincolnshire, IL (US)

(73) Assignee: Klein Tools, Inc., Lincolnshire, IL (US)

(21) Appl. No.: 16/354,977

(22) Filed: Mar. 15, 2019

Related U.S. Application Data
(60) Provisional application No. 62/647,205, filed on Mar. 23, 2018.

(51) Int. Cl. B25F 1/04; B25F 1/00; B25G 1/08

(52) U.S. Cl. CPC B25F 1/04; B25G 1/085; B25F 1/003

(57) ABSTRACT

A folding multi-tool includes a first tool defined by a pair of tool members connected to each other at a pivot, each tool member having a base portion spaced from the pivot, and a pair of elongate handles, at least one of the handles defining at least one tool storage area within the handle. A bit driver includes an elongate outer sleeve connected to one of the handles to pivot between a stowed position where the bit driver is stowed in the at least one the storage area and a deployed position where the bit driver can be operated by a user.

### BACKGROUND OF THE INVENTION

Pocket multi-tools are generally known. Such tools typically include various folding devices such as scissors, pliers, knife blades, files, saws, screwdrivers, can and bottle openers, and the like. One example of a known pocket multi-tool can be seen in U.S. Pat. No. 5,711,194 (“Anderson 1”). Anderson describes a folding knife, which includes a single or dual folding sleeves, each of which can accommodate a screwdriver bit.

Another example of a multi-tool can be seen in U.S. Pat. No. 6,000,080 (“Anderson 2”). Anderson 2 describes an adaptor that mates with a hand tool such as a folding multipurpose tool to make use of the multipurpose tool as a handle to turn tool bits of various sizes.

### BRIEF SUMMARY OF THE INVENTION

The present disclosure describes a folding multi-tool that includes a plurality of folding devices. One of the devices is shaped like a sleeve and accommodates therein an inner sleeve, which in turn accommodates two dual-sided driver bits. The sleeve includes a pronounced feature to facilitate opening of the device relative to the handle, and further provides a flat and/or rectangular feature that can be engaged by a wrench or pliers to increase the torque that can be applied to a fastener engaged by the multi-tool. Moreover, the multi-tool has a dual handle or “butterfly” configuration in which one side is shorter than the other, to provide a tapered overall shape that advantageously provides an improved grip surface for the user. These and other structures and features are described in further detail below.

### BRIEF DESCRIPTION OF THE SEVERAL VIEWS OF THE DRAWING(S)

FIGS. 1 and 2 are outline views from different perspectives of a multi-tool in accordance with the disclosure in a first operating configuration.

FIG. 3 is an outline view of the multi-tool of FIG. 1 with various attachments in an opened condition.

FIG. 4 is an outline view of the multi-tool of FIG. 1 in a second operating configuration.

FIGS. 5 and 6 are outline views of different perspectives of the multi-tool of FIG. 1 in a third operating configuration.

FIG. 7 is a side view of the multi-tool of FIG. 4.

FIG. 8 is a cross section of the multi-tool in the configuration shown in FIGS. 4 and 7.

FIG. 9 is an enlarged detail view of a portion of the multi-tool shown in cross section in FIG. 8.

### DETAILED DESCRIPTION OF THE INVENTION

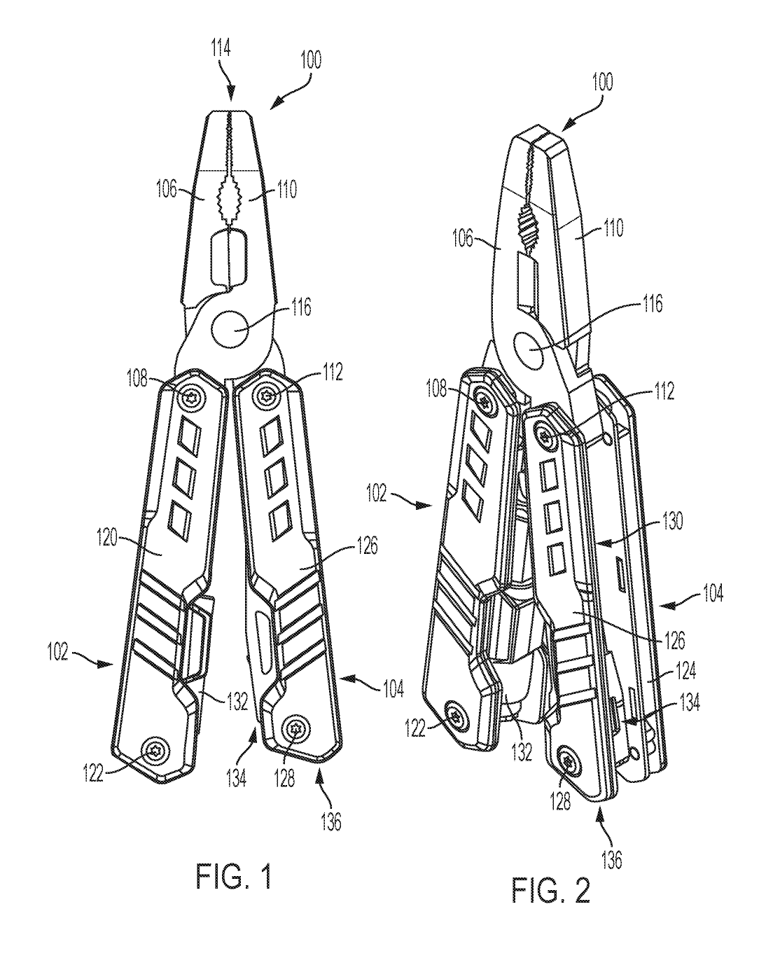

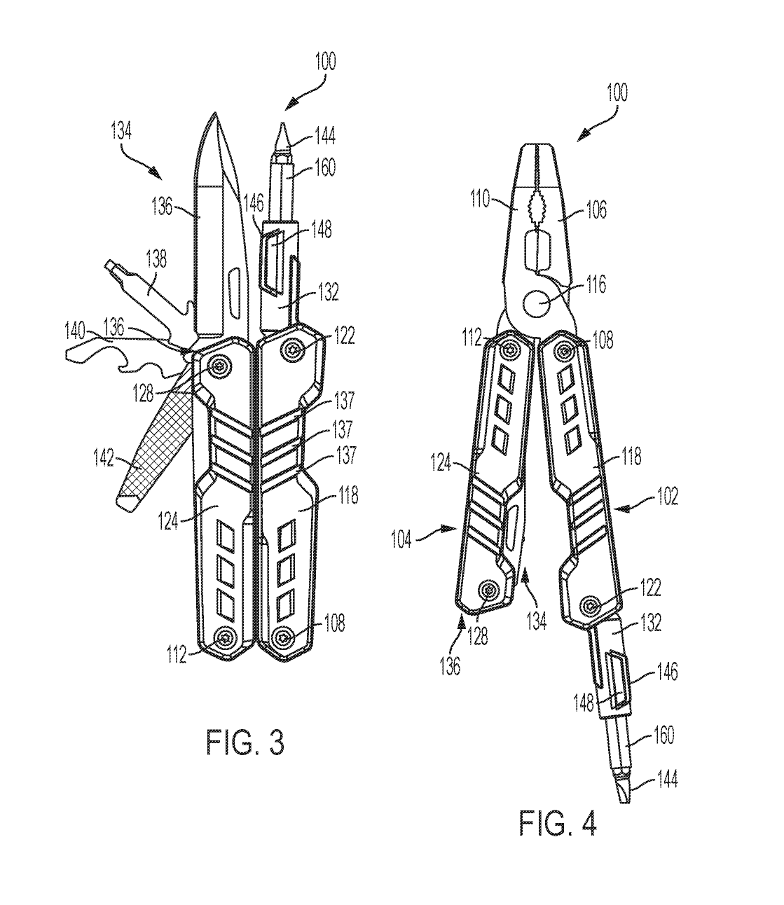

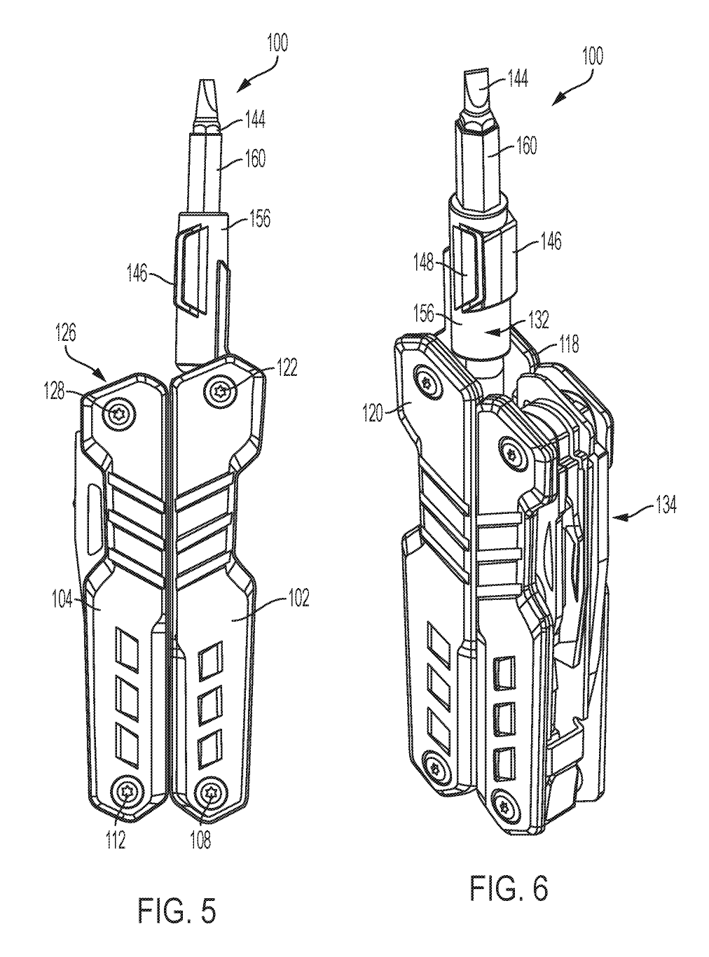

A multi-tool 100 is shown in various operating configurations and from various perspectives in FIGS. 1-9. In reference to these figures, the multi-tool 100 includes a first handle assembly 102 and a second handle assembly 104. The first handle assembly 102 is connected to a first jaw 106 at a first pin joint 108, and the second handle assembly 104 is connected to a second jaw 110 at a second pin joint 112 to form a pair of pliers 114. The pliers shown are blunt-nosed, but needle-nosed or other structures such as a pair of scissors can also be used. The first and second jaws 106 and 110 are pivotally connected to one another at a pivot 116. The pliers 114 are shown in an open position in FIGS. 1 and 2. To close the pliers 114 as shown, for example, in FIG. 3, the first handle assembly 102 can pivot relative to the first jaw 106 about the first pin joint 108 and towards the first jaw 106, and the second handle assembly 104 can pivot relative to the second jaw 110 about the second pin joint 112 and towards the second jaw 110, until internal spaces (as will be described below) in each of the first and second handle assemblies 102 and 104 cover the pliers 114 and meet. When in the open position, the pliers 114 can be operated by a user moving the first and second handle assemblies 102 and 104, and thus also the first and second jaws 106 and 110, about the pivot 116. As can be appreciated, the handles are rotatably prevented from rotating past their open positions relative to the first and second pin joints 108 and 112 in a direction away from the pliers 114 when the pliers 114 are in the open position as shown, e.g., in FIG. 1.

The first handle assembly 102 is made from first and second body plates 118 (see FIGS. 3 and 4) and 120, which are connected to one another at the first pin joint 108 and also at a first outer pin joint 122. Similarly, the second handle assembly 104 is made from first and second body plates 124 and 126, which are likewise connected to one another at the second pin joint 112 and also at a second outer pin joint 128. The pin joints together with the first and second body plates in each of the first and second handle assemblies 102 and 104 define a gap 130 between the corresponding body plates, which accommodate the jaws of the pliers when the multi-tool is closed, and also other devices.

In the illustrated embodiment, the first handle assembly 102 includes a folding bit driver assembly 132, which is pivotally attached to the first handle assembly 102 around a portion of the first outer pin joint 122 that is disposed in the gap 130. The second handle assembly 104 includes a plurality of folding tools 134 that are pivotally attached to the second handle assembly 104 around a portion of the second outer pin joint 128 that is disposed in the gap 130. As can be seen from FIG. 1, an outer end 136 of the second handle assembly 104 is shorter than the outer end of the first handle assembly 102. This difference in length, along with additional features such as grooves 137 aid in gripping the multi-tool during use.

The plurality of folding tools 134 can include any variety of folding tools. As shown in FIG. 3, the plurality of folding tools 134 in the illustrated embodiment includes a knife, a flat screwdriver 138, a bottle/can opener 140 and a file 142, but any other such tools can be used. The folding bit driver assembly 132 includes a tubular socket that accommodates a driver bit 144 and a platform 146 along its length that defines two thumb cavities 148. The platform 146 provides a flat surface, as shown in FIG. 6, which can be used to provide additional torque by engaging the shaft with a wrench or pliers. The platform 146 in the embodiment shown is rectangular and disposed along a plane that is tangential to the outer cylindrical shape of the sleeve of the driver assembly 132. The platform 146 also defines the thumb cavities 148 below to aid the user opening the folding bit driver assembly 132. The thumb cavities 148 are defined on both sides of the platform 146 under an overhang thereof. A width of the platform 146 as shown is about equal to the diameter of the cylindrical sleeve of the driver assembly 132, but a greater width can be used to provide a larger area to engage the driver and also a larger thumb cavity 148. The two thumb cavities 148 have the same size on either side of the sleeve of the driver 132 but can alternatively have different sizes, including having only one thumb cavity on only one side of the sleeve of the driver assembly 132.

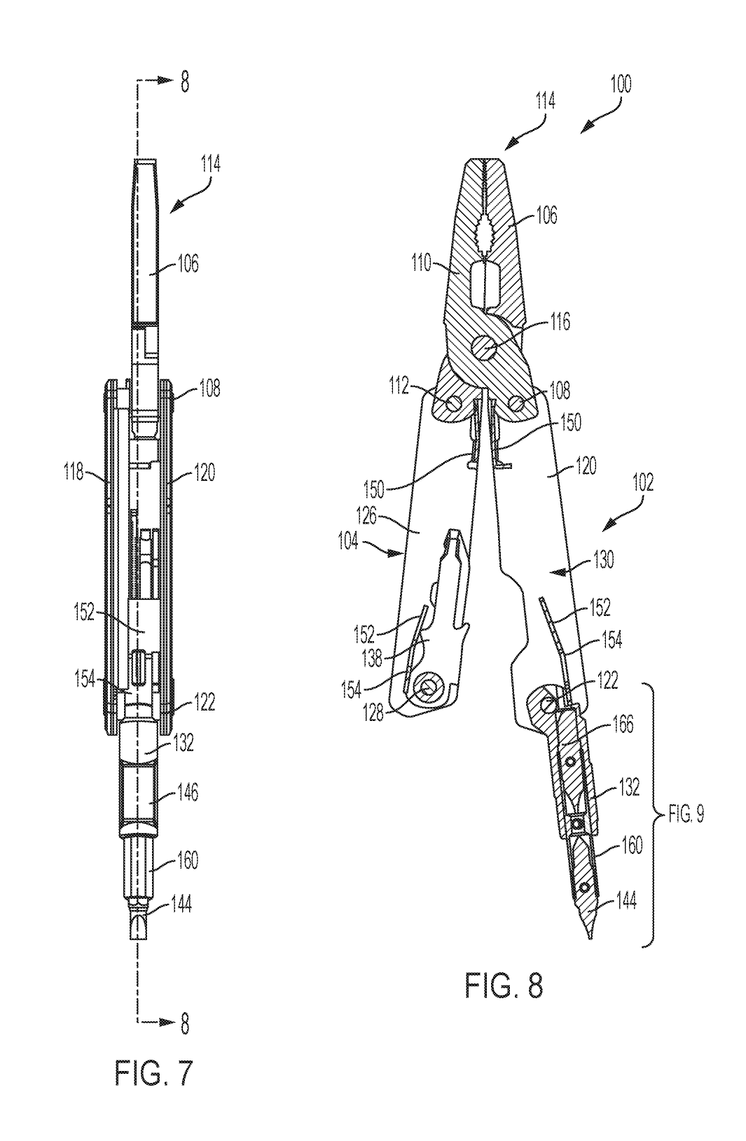

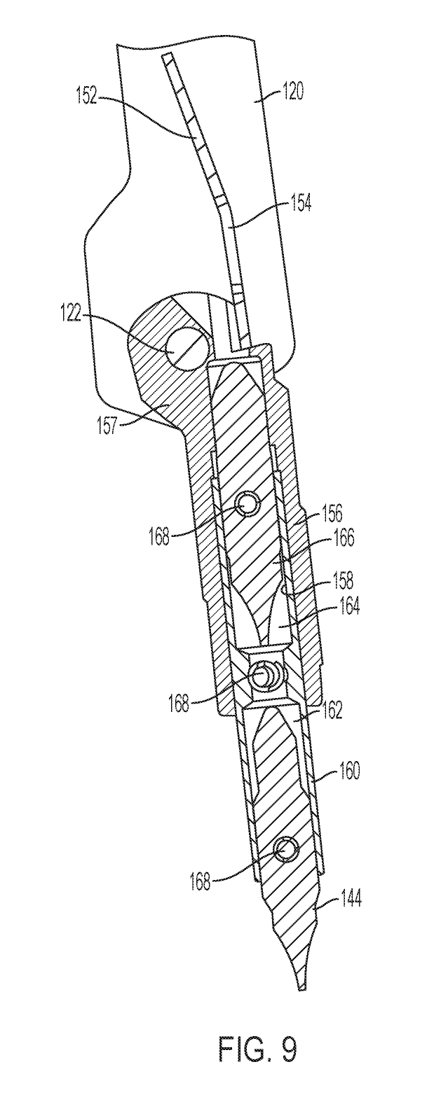

A cross section through a portion of the multi-tool 100 is shown in FIGS. 7 and 8, and an enlarged detail view is shown in FIG. 9. In reference to these figures, each of the first and second handle assemblies 102 and 104 includes a stop 150 disposed adjacent the first and second pin joints 108 and 112 and extending transversely at least partially across the gaps 130 such that it contacts features formed in the periphery of the first and second jaws 106 and 110 around the respective pin joints. The stops 150, which are rigid, help transfer motion from the handles to the jaws to operate the pliers 114 when the multi-tool 100 is open, and to also limit travel of the jaws relative to the handles when the multi-tool is closed.

On the opposite, outer ends of the first and second handles 102 and 104, two similar bridges 152 having springs 154 attached on their ends are disposed adjacent the pin joints 122 and 128. As shown in FIG. 8, and also FIG. 9, each bridge 152 spans the width of the gap 130 and includes an extension, which acts as a leaf spring, that resiliently contacts hinge portions of the driver 132 and other devices 134, for example, the opener 138. The springs 154 limit the free rotation of these hinges and help keep the devices in place when unfolded or open, and closed, when the multi-tool 100 is in the closed position.

An enlarged detail of the driver 132 is shown in FIG. 9. In reference to this figure, it can be seen that the driver 132 includes an outer sleeve 156. The outer sleeve 156 had a generally hollow cylindrical shape forming a bore 158 that is open at one end. At an opposite end, the outer sleeve 156 forms a hinge 157 having an opening that is pivotally connected around a portion of the pin joint 122 to permit rotation of the sleeve 156 relative to the handle, e.g., the plate 120. The bore 158 of the outer sleeve 156 has a non-circular cross section, for example, a hexagonal cross section, which includes flats that engage corresponding flats on a driven component disposed therein to transmit torque therebetween. While the bore 158 can accommodate a driver bit directly, in the illustrated embodiment, an inner sleeve 160 having two opposing bores 162 and 164 is disposed in the outer sleeve 156. Each bore 162 and 164 rotatably and releasably slidably engages and includes a driver bit such as the driver bit 144 and a second driver bit 166. Each driver bit 144 and 166 has dual working ends, for example, small or large flathead or phillips head drivers, to provide a total of four bits that can be used by removing, rotating and replacing the inner sleeve 160 and each of the driver bits 144 and 166 into the outer sleeve 156. As can be seen from the figures, the outer sleeve has a hexagonal inner and outer profile that is dimensioned such that the outer sleeve rotatably engages the outer sleeve 156 and also each of the driver bits 144 and 166 rotatably and slidably engages the bores 162 and 164 of the inner sleeve 160. The rotatable engagement is provided in all cases by the hexagonal profiles. The slidable engagement is provided by spring loaded spheres 168, which are disposed between the outer and inner sleeves, and also between each of the two driver bits and the inner sleeve bores.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A folding multi-tool comprising:
a first tool defined by a pair of tool members connected to each other at a pivot, each tool member having a base portion spaced from the pivot;
a pair of elongate handles connected to the tool members to allow manual actuation of the tool members relative to each other, one handle connected to one of the base portions, the other handle connected to the other base portion, at least one of the handles defining at least one tool storage area within the handle; and
a bit driver comprising:
an elongate outer sleeve connected to one of the handles to pivot between a stowed position where the bit driver is stowed in the at least one the storage area and a deployed position where the bit driver can be operated by a user, the outer sleeve having a drive bore that is open at an end of the outer sleeve, the drive bore having a non-circular cross section;
an elongate inner sleeve releasably received in the drive bore, the inner sleeve having:
an outer surface extending between opposite ends of the inner sleeve, the outer surface having a non-circular cross section that engages the non-circular cross section of the drive bore,
a first driver bit receptacle in one of the opposite ends of the inner sleeve, and
a second driver bit receptacle in the other of the opposite ends of the inner sleeve; and
two reversible driver bits, each of the driver bits having dual working ends, one of the driver bits releasably received in the first driver bit receptacle with one of the working ends of the one of the driver bits extending outside of the inner sleeve, the other of the driver bits releasably received in the second driver bit receptacle with one of the working ends of the other of the driver bit extending outside of the inner sleeve.

2. The folding multi-tool of claim 1 wherein a portion of the inner sleeve extends outside of the outer sleeve.

3. The folding multi-tool of claim 1 wherein both of the handles define at least one tool storage area.

4. The folding multi-tool of claim 3 further comprising a plurality of tools, each of the plurality of tools connected to a corresponding one of the handles to pivot between a stowed position where the tool is stowed in one of the at least one tool storage areas and a deployed position where the tool extends from the corresponding one of the handles to be operated by a user; and wherein the plurality of tools comprises the bit driver.

5. The folding multi-tool of claim 4 wherein the plurality of tools comprises the first tool, and the tool members are plier jaws.

6. The folding multi-tool of claim 1 wherein each of the working ends is different from the other working ends so that the two driver bits provide four unique working ends.

7. The folding multi-tool of claim 1 wherein the outer sleeve is pivotally connected to the one of the handles by a pin joint at a location spaced from the end of the outer sleeve.

8. The folding multi-tool of claim 1 wherein the one of the handles is connected to the one of the base portions by a first pin joint and the other of the handles is connected to the other of the base portions by a second pin joint to allow the first tool to be pivoted relative to the handles between a stowed position where the first tool is stowed in at least one tool storage area in at least one of the handles and a deployed position where the first tool can be operated by a user.

9. The multi-tool of claim 1 wherein the non-circular cross section of the outer surface of the inner sleeve extends continuously between the opposite ends of the inner sleeve, and the non-circular cross sections of the drive bore and the outer surface of the inner sleeve are hexagonal.

10. The multi-tool of claim 1 wherein the one of the handles comprises first and second body plates connected to each other by a pair of pin joints, and the first and second body plates are spaced from each other to define the at least one tool storage area that receives the bit driver in the stowed position.

11. The multi-tool of claim 10 where the other of the handles comprises third and fourth body plates connected to each other by another pair of pin joints, and the third and fourth body plates are spaced from each other to define at least one tool storage area.
